(19) United States
(12) Patent Application Publication
(10) Pub. No.: US 2026/0346317 A1
(43) Pub. Date: Nov. 5, 2026

(54) METHOD FOR ANALYSING THE VIBRATION BEHAVIOUR OF A SYSTEM

(71) Applicant: SMS group GmbH, Mönchengladbach (DE)

(72) Inventors: Stefan KLANKE, Düsseldorf (DE); Matthias KRÜGER, Kappeln (DE); Sebastian RICHARD, Hilchenbach (DE)

(73) Assignee: SMS group GmbH, Mönchengladbach (DE)

(21) Appl. No.: 19/117,996

(22) PCT Filed: Sep. 12, 2023
(86) PCT No.: PCT/EP2023/074954

§ 371 Date: Apr. 23, 2025

(30) Foreign Application Priority Data
Oct. 6, 2022 (DE) 10 2022 210 596.6

(51) Int. Cl. B21B 38/00; G01H 1/00

(52) U.S. Cl. CPC B21B 38/008; G01H 1/003

(57) ABSTRACT

A method analyzes the vibration behavior of a system with two rolling mill stands, which are coupled to one another via a strip stretched into both rolling mill stands. Amplitude spectra of the two rolling mill stands are created and then a common frequency range is searched for and identified in which the two amplitude spectra are compared with one another. A chatter event is detected for the system only if peaks of these two amplitude spectra are in the common frequency range and if both peaks have amplitudes above defined amplitude threshold values.

### CROSS-REFERENCE TO RELATED APPLICATION

This application is a national stage application, filed under 35 U.S.C. § 371, of International Patent Application PCT/EP2023/074954, filed on Sep. 12, 2023, which claims the benefit of German Patent Application DE 10 2022 210 596.6, filed on Oct. 6, 2022.

### TECHNICAL FIELD

The disclosure relates to a method for analyzing the vibration behavior of a system consisting of at least a first and a second rolling mill stand, which are coupled to one another via a strip e.g. of metal, clamped in both rolling mill stands.

### BACKGROUND

The present disclosure concerns a particular vibration behavior of rolling mill stands, which is also referred to as chatter.

The term “chatter” refers to pronounced vibrations that can occur when rolling steel or aluminum strips. The phenomenon is known to occur in both hot-strip and cold-strip lines, and also in both individual rolling mill stands and multi-stand rolling lines. Chatter is particularly critical when cold rolling mostly thin strips. Here, characteristic are the so-called 3^{rd} octave and 5^{th} octave chatter vibrations, which are named after the position of the vibration frequency in the respective musical octave range (3rd octave: 110-220 Hz, 5th octave: 440-880 Hz). Depending on the intensity of the vibration, the resulting problems range from quality losses in the rolled products, e.g. thickness or surface, to damage to components, e.g. markings on rolls or bearings, up to strip breakage. A broken strip signifies loss of production and possibly consequential damage to equipment and personnel.

It is known in the prior art to prevent chatter in rolling mill stands by providing suitable damping. With or without damping, undesirable chatter events can occur, particularly in systems consisting of at least two coupled rolling mill stands. These events must be detected/warned against in advance.

The European patent application EP 3 903 953 A1 describes a method for recognizing chatter in a cold rolling mill stand. Specifically, this method proposes capturing vibrations at the cold rolling mill stand with the aid of a sensor in the time range, and subsequently transforming this time signal into the frequency range for analysis there. Specifically, the method provides for the recognition of a chatter event in the event that a peak in the amplitude spectrum of the signal exceeds a predetermined threshold value.

### SUMMARY

The disclosure is based on the object of further developing a known method for analyzing the vibration behavior of a system with regard to the occurrence of critical oscillation situations (chatter events), in such a way that it can be advantageously used for systems with a plurality of coupled rolling mill stands.

This object is achieved by the method as disclosed and claimed. Accordingly, a chatter event is detected for a system consisting of at least two coupled rolling mill stands if two conditions are fulfilled simultaneously:

First, there must be a first peak in the first amplitude spectrum and at least one second peak in the second amplitude spectrum, both of which are in a common frequency range (method steps e) and f)), and secondly, the first peak must also exceed a predetermined first amplitude threshold value and the second peak must exceed a second predetermined amplitude threshold value (method step g)). Only if at least these two conditions are fulfilled is the chatter event reliably detected. The first and second amplitude threshold values can be the same or different.

The terms “spectrum” and “amplitude spectrum” are used synonymously.

The dependent claims define various scenarios/exemplary embodiments with which the two check criteria in accordance with method step f) and in accordance with method step g) are only partially fulfilled. In these cases, the chatter event cannot yet be reliably detected; however, trends, i.e. temporal developments in the amplitude or frequency of the peaks in the amplitude spectra, are observed to determine whether they are developing towards fulfillment of the two conditions in accordance with method step f) and in accordance with method step g). In these cases, the present method provides that advance warnings are issued.

In accordance with a further exemplary embodiment, the detection of the chatter event or the timely advance warning thereof can be linked to an additional condition, for example that
the correlation of the two signals in the time interval is above the correlation threshold value; and/or
the natural frequencies of the first and/or the second rolling mill stand are within the common frequency range and preferably also within the further (narrower) common frequency range; and/or
the frequency of the first peak and the frequency of the second peak are within a further common frequency range, which is narrower than the common frequency range; and/or
an amplitude gradient determined in accordance with the formula

grad Pn=(Pn(t₂)−Pn(t₁))/Δt (1)

is above an individual gradient threshold value for the first rolling mill stand n=1, wherein the following applies:
n rolling mill stand
t1, t2 time interval 1, time interval 2
Δt time difference t2−t1=constant
Pn amplitude of the peak for the rolling mill stand n1
   and either the amplitude of the peaks of the amplitude spectrum of the second rolling mill stand have already been or are above the associated amplitude threshold value during time intervals 1, 2 and 3, or the gradient for the second rolling mill stand in accordance with the formula is also above an individual gradient threshold value.

In each case, all of these criteria make it possible to evaluate the similarity of the first and second amplitude spectra. The more similar the two spectra are, the more reliably the chatter event can be predicted or detected.

In accordance with a further exemplary embodiment, the first and/or the second amplitude spectrum is interpolated in the frequency range prior to performing one of the check steps and/or one of the comparison steps. This interpolation makes possible a more precise determination of the maximum value of a peak along with a more precise determination of its frequency. This more precise determination of the amplitude and frequency of a peak also makes possible an improved prediction or detection of the chatter event.

The detection of the chatter event and/or at least one of the advance warnings beforehand is preferably issued to an operator of the system or to an automatic process control of the system. The information about the detection or the advance warning can, for example, be linked to the recommendation to slow down the system in order to prevent a build-up of vibrations, i.e. undesirable resonance effects.

The method can be used for both cold rolling mill stands and hot rolling mill stands.

The various procedures mentioned in the present description for detecting a chatter event or for generating a corresponding advance warning can be combined with one another as desired in order to increase the accuracy of the prediction. Advantageously, the present invention provides for the simultaneous use of a plurality of different signals and criteria—optionally also in combination—to avoid false triggering while simultaneously lowering warning thresholds.

The above-mentioned object of the invention is further achieved by a computer program product in accordance with patent claim 10. The advantages of this solution correspond to the advantages mentioned above with reference to the claimed method.

The first and/or second sensor can be measurement technology already present in the rolling mill stands, such as pressure sensors in the setting and bending cylinders, load cells or outside the rolling mill stands in the form of thickness gauges for the metal strip. Equipment for analyzing these measurement signals may already be available and does not need to be purchased in addition. If these sensors are used for performing the method, this has the advantage that no additional costs are associated with it. If, in addition to these sensors, other sensors are also used for performing the method, an increase in accuracy is realized, again at no additional cost. Such additional sensors and measurement technology for capturing the temporal vibration signals can, for example, be arranged in the intermediate stand region, i.e. between the first and second rolling mill stands. The additional sensors can be tension load cells or acceleration sensors, for example. This additional measurement technology may be associated with additional costs.

When the method is performed in a system with active vibration damping in a rolling mill stand, vibrations are suppressed in this stand. That is, the amplitudes of the peaks are sometimes low and the frequencies of the peaks are not always recognizable. That is, capturing the vibrations on the respective stand, as required for performing the method, is then not readily possible. In this case, the inclusion of available information from the active vibration damping system, such as the control signal of the system and its spectral analysis, can provide a remedy.

The first and second sensors for capturing the vibrations on the first and second rolling mill stand do not necessarily always have to be attached directly to the stand. For performing the method, it is sufficient if these sensors in each case generate a signal that represents the vibrations on the rolling mill stands/from which the vibrations on the rolling mill stands can be derived.

### BRIEF DESCRIPTION OF THE DRAWINGS

The description is accompanied by a total of 14 figure.

FIG. 1 illustrates a schematic representation of the method for analyzing the vibration in rolling mill stands in the form of a flow chart;

FIG. 2 illustrates the transformation of time signals into the frequency range;

FIGS. 3 and 4 illustrate the finding/identification of a common frequency range for a first and a second amplitude spectrum;

FIGS. 5 and 6 illustrate the use of a correlation of the first and second amplitude spectra for verifying their similarity;

FIG. 7 illustrates the observation of an increase in the amplitude of the first peak over time as a criterion for issuing an advance warning of an impending chatter event;

FIG. 8 illustrates the observation of an increase in the amplitude of the second peak as an advance warning of the occurrence of an impending chatter event;

FIG. 9 illustrates the observation of an increase in the amplitudes of both the first peak and the second peak as a scenario for an impending chatter event;

FIG. 10 illustrates the observation of a shift in the frequency of the second peak in the course of time into the common frequency range as an impending scenario for a possible chatter event;

FIG. 11 illustrates an interpolation of the spectrum of a signal in the frequency range for improving the resolution of the maximum value of the amplitude and/or the frequency of a peak;

FIG. 12 illustrates the additional evaluation of the proximity of the frequency of a peak to relevant natural frequencies of the respective rolling mill stands as a further criterion for the detection of a chatter event; and

FIGS. 13 and 14 illustrate the additional evaluation of a gradient of peak amplitudes in the amplitude spectrum of at least one rolling mill stand as a further criterion for the detection of a chatter event.

### DETAILED DESCRIPTION

The invention is described in detail below with reference to the said figures in the form of exemplary embodiments. In all figures, the same technical elements are designated with the same reference signs.

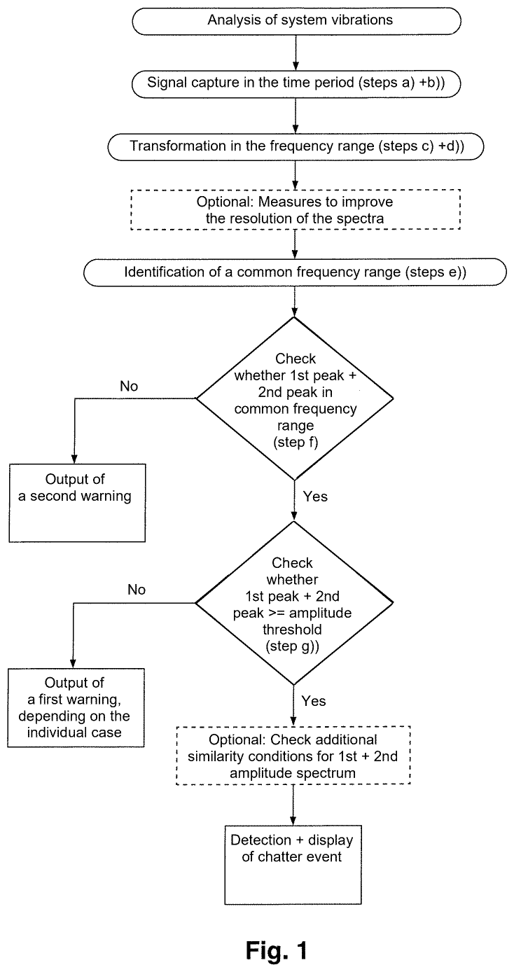

FIG. 1 illustrates the method for analyzing the vibration behavior of a system comprising at least a first and a second rolling mill stand, which are both coupled to one another by a clamped strip, in particular a metal strip. The method comprises the following steps: a) capturing the vibrations at the first rolling mill stand n with a first sensor in the form of a first temporal vibration signal; and b) capturing the vibrations at the second rolling mill stand n+1 with a second sensor in the form of a second temporal vibration signal, simultaneously with the capturing of the vibrations at the first rolling mill stand. The second rolling mill stand n+1 is arranged downstream of the first rolling mill stand n in the rolling direction of the strip. As previously mentioned in the general part of the description, the sensors for capturing the vibrations in the time domain, in particular in a time interval, do not necessarily have to be attached to the rolling mill stands themselves; rather, it is sufficient if the sensors in each case generate a signal in a time interval that represents the vibrations at the respective rolling mill stand.

After this signal capturing in the time domain, the temporal sensor signals are transformed into the frequency domain, typically with the aid of a Fourier transformation; see method steps c) and d) in claim 1.

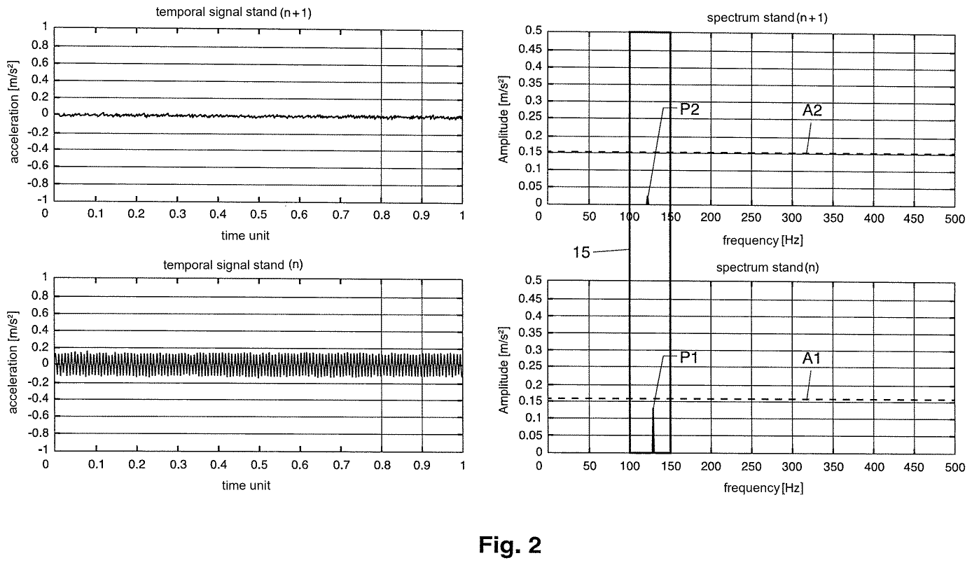

FIG. 2 illustrates this transformation of vibration signals from the time domain to the frequency domain. Specifically, the graph at the bottom left of FIG. 2 shows the vibration behavior of a rolling mill stand n in a time interval and the associated amplitude spectrum can be seen to the right. The amplitude spectrum here has, by way of example/in an idealized case, only a first peak P1 whose amplitude here, again by way of example, is below a predetermined first amplitude threshold value A1. The top left of FIG. 2 shows, again by way of example, the temporal signal, which shows the vibration behavior of the second rolling mill stand n+1 downstream of rolling mill stand n. To the right is the corresponding amplitude spectrum after a Fourier transformation. This amplitude spectrum, again in an idealized case, consists only of a single peak P2 whose amplitude is obviously smaller than an associated second amplitude threshold value A2. The first amplitude threshold value A1 and the second amplitude threshold value A2 can be the same, but they do not have to be. Furthermore, a common frequency range 15 is defined for the two amplitude spectra, in which the respective peaks are to be compared with one another.

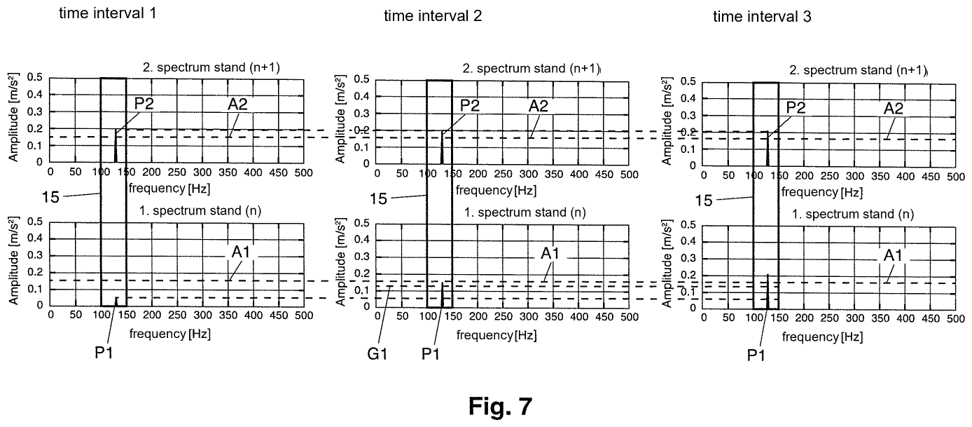

The identification of the common frequency range 15 is carried out in accordance with FIG. 1 and claim 1 in method step e). A subsequent first check step f) asks whether the first peak P1 and the second peak P2 both are in the common frequency range 15; this check step must be answered in the affirmative for the example shown in FIG. 2. However, the maximum value/amplitude of the first peak P1 is below the associated first amplitude threshold value A1 and the maximum value/amplitude of the second peak P2 is significantly below its associated second amplitude threshold value A2; a second check step g) must therefore be answered in the negative. In this respect, FIG. 2 is an example of the fact that no chatter event is detected in accordance with the method. The further procedure in this case is described in more detail below with reference to FIGS. 7-9 and FIGS. 13 and 14.

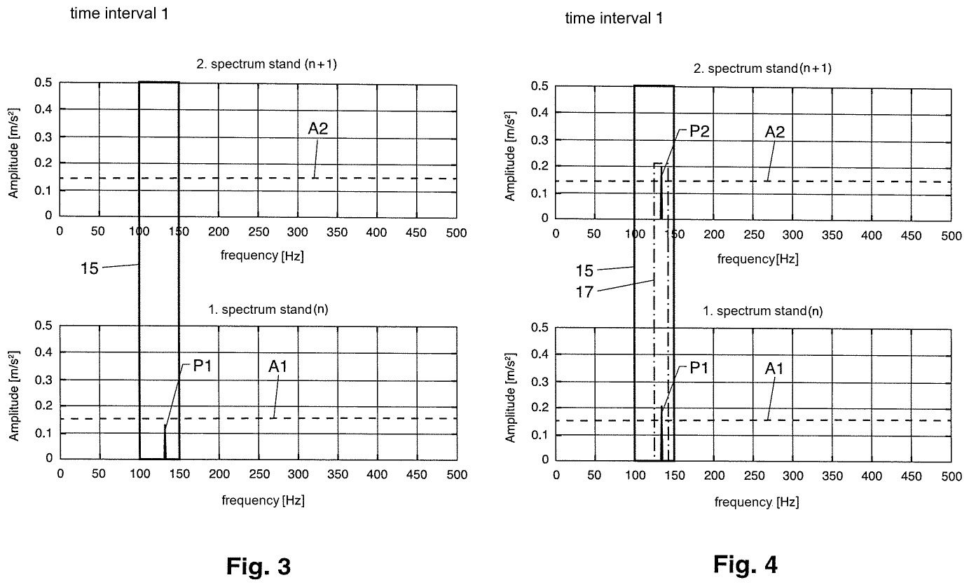

FIG. 3 shows another example of the fact that no chatter event is detected in accordance with the method. In this example, detection fails because only the first peak P1 of the first amplitude spectrum can be recognized in the identified common frequency range 15; see lower graph. However, no second peak P2 of the second amplitude spectrum can be seen in the common frequency range 15; see the upper graph of FIG. 3. The 1st check step f) is therefore not fulfilled here. The further procedure in this case is described further with reference to FIG. 10.

Finally, FIG. 4 finally shows the case in which a chatter event is detected in accordance with the method. As can be seen in FIG. 4, this is particularly the case if the following two conditions are fulfilled:
1. There is a common frequency range 15 in which both a first peak of the first amplitude spectrum (lower graph) and a second peak of the second amplitude spectrum (see upper graph in FIG. 4) are located; see check step f). In addition, as a second condition, the second check step g) is fulfilled, namely that both the maximum value of the first peak P1 of the first amplitude spectrum are above its corresponding amplitude threshold value A1, and the maximum value of the second peak P2 are above its corresponding amplitude threshold value A2.

FIG. 4 illustrates a further condition, which is not mandatory for the detection of the chatter event, but is merely optional. This condition consists in the fact that the frequencies of the first peak P1 and the second peak P2 are not only both within the common frequency range 15, but also additionally within a further frequency range 17, which is even narrower than the common frequency range 15. The presence of this condition indicates a sufficient match between the two spectra and, if applicable, underpins the detection of the chatter event.

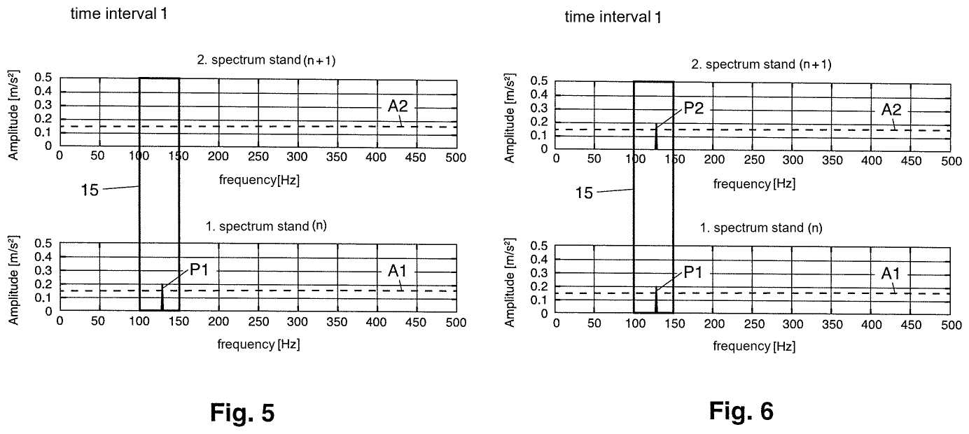

FIGS. 5 and 6 in each case consist of two graphs arranged one above the other. The two graphs arranged above one another in each case substantially correspond to FIGS. 3 and 4, apart from the further common frequency range 17, which is not shown in FIGS. 5 and 6.

It can be seen in FIG. 5 that in the first lower amplitude spectrum, the maximum value of the first peak P1 is above its associated first amplitude threshold value A1. No peak of the upper second amplitude spectrum for the neighboring rolling mill stand n+1 is within the common frequency range 15. This corresponds to a maximum dissimilarity of the two spectra in the common frequency range. The correlation measure, which illustrates the similarity of the amplitude spectra arranged one above the other, is zero here, and thus below any predetermined correlation threshold value. In the example shown in FIG. 5, the check steps f) and g) are not fulfilled and, in addition, the optional correlation criterion, according to which the correlation of the two signals in time interval 1 must be above the correlation threshold value, is also not fulfilled.

The exemplary embodiment shown in FIG. 6 differs from the exemplary embodiment shown in FIG. 5 only in that, in this case, the second peak P2 of the second upper amplitude spectrum is also within the common frequency range 15. In this case, there is maximum similarity between the two spectra, which is expressed in a correlation measure/correlation coefficient of 1. This correlation measure is above the correlation threshold value KO and thus confirms the detection of a chatter event, as is in principle given by the presence of the first peak P1 and the second peak P2 in each case within the common frequency range 15 and in each case above their associated amplitude threshold values A1 and A2. Both the check steps f) and g) as well as the optional correlation criterion are fulfilled.

The criteria for a high similarity between the first and second amplitude spectra described above with reference to FIGS. 2-6 are merely optional conditions that should preferably likewise be fulfilled in addition to the check steps f) and g) in order to reliably detect a chatter event. If some of these conditions do not indicate a strong similarity between the first and second amplitude spectra, the detection of the chatter event is associated with a greater uncertainty/ambiguity than if there is a high similarity. The same applies to the advance warnings issued within the framework of the method for the occurrence of a chatter event in the future.

FIGS. 7-9 illustrate three case scenarios in accordance with the method as shown in FIG. 1, wherein the first check step f) is fulfilled in each case, i.e. the first peak of the first amplitude spectrum and the second peak of the second amplitude spectrum are always in the common frequency range 15. However, the second check step g) is—at least initially—not fulfilled. In order to obtain an estimate of whether a chatter event is imminent in the future in these cases as well, it is necessary to generate the first amplitude spectrum for the first rolling mill stand n and the second amplitude spectrum for the second rolling mill stand n+1 not only for a first time interval 1, but also at least for a second time interval 2 in each case. In each case, three spectra for different time intervals 1, 2 and 3 are shown horizontally next to one another in FIGS. 7-9. This comparison makes it possible to recognize a possible trend in the temporal development of the first peak P1 and/or the second peak P2. The time intervals 1-3 in FIGS. 7-10 and 13-14 in each case designate different time intervals of the temporal measurement signals on which the spectra are based, which follow one after the other with or without a pause.

In accordance with the second check step g), the method provides for checking whether the first peak P1 and the second peak P2 are in each case above their associated amplitude threshold values A1 and A2. In FIG. 7, this applies to the spectra that represent the first time interval only for the second spectrum, but not for the first spectrum. The maximum value/amplitude of the first peak P1 is well below the first amplitude threshold value A1. In this respect, the check step g) must be answered in the negative in this case. In this case, the method provides for the case that the amplitude spectra of the vibration signals for the first rolling mill stand are generated not only for the first time interval, but also for a second and optionally also for a third time interval. A comparison of the first amplitude spectrum for the time interval 2 with the first amplitude spectrum for the time interval 1 shows an increase in the amplitude of the first peak P1, although its amplitude is still below the associated first amplitude threshold value A1. The first peak P1 is still within the common frequency range 15 together with the peak P2. The amplitude of the second peak P2 is still above the 2nd amplitude threshold value A2. However, because, as already mentioned, the amplitude of the first peak P1 is still below the first amplitude threshold value A1, no chatter event can be reliably detected in this case. However, due to the recognized increase in amplitude of the first peak P1 over time (first early indicator), for example beyond a first limit value G1, which is below the first amplitude threshold value A1, a first advance warning can be issued in this case that the critical chatter of the system could occur. This would be the case if the amplitude of the first peak P1 were to increase further in the course of time and at some point exceed the associated first amplitude threshold value A1, as shown in FIG. 7 for the time interval 3. For the situation as shown in FIG. 7 for the third time interval 3, the detection of the chatter event would be issued/displayed in accordance with the method, because the conditions in accordance with the first check step f) and the second check step g) would both be fulfilled.

The issuance of the said first advance warning with regard to the future occurrence of the chatter event can be made dependent on a first limit value G1 being reached. Only if this first limit value G1, which is only slightly below the first amplitude threshold value A1, is reached or exceeded, and if the amplitude of the first peak P1 is still below the first amplitude threshold value A1 at the same time, is the said first advance warning issued.

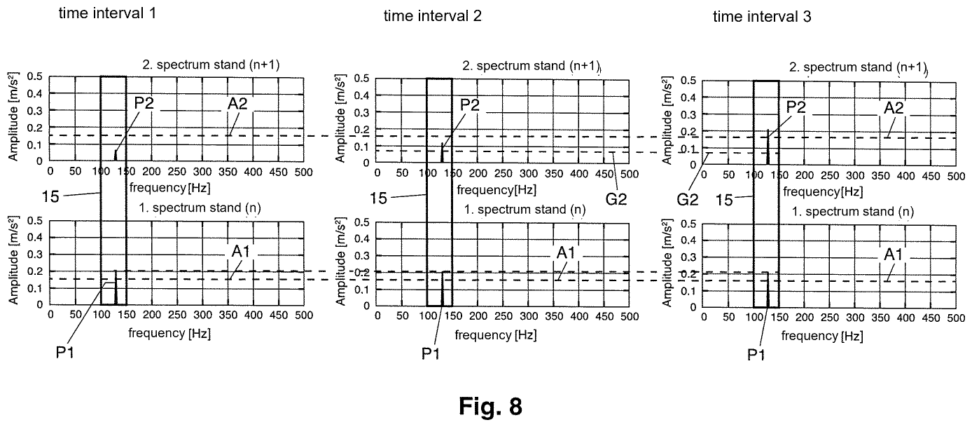

The explanations for FIG. 7 apply analogously to FIG. 8. In FIG. 8, it is assumed that the amplitude of the first peak P1 is in each case above its associated first amplitude threshold value A1 in all three time intervals and that an increase in the second peak P2 can be observed in the course of time, the second early indicator, up to the exceeding of the second amplitude threshold value A2. Here as well, the issuance of a first advance warning of a possible chatter event in the future can be made dependent on whether the amplitude of the second peak P2 has already exceeded a second limit value G2, which is below the second amplitude threshold value A2, and at the same time has not yet exceeded the second amplitude threshold value A2.

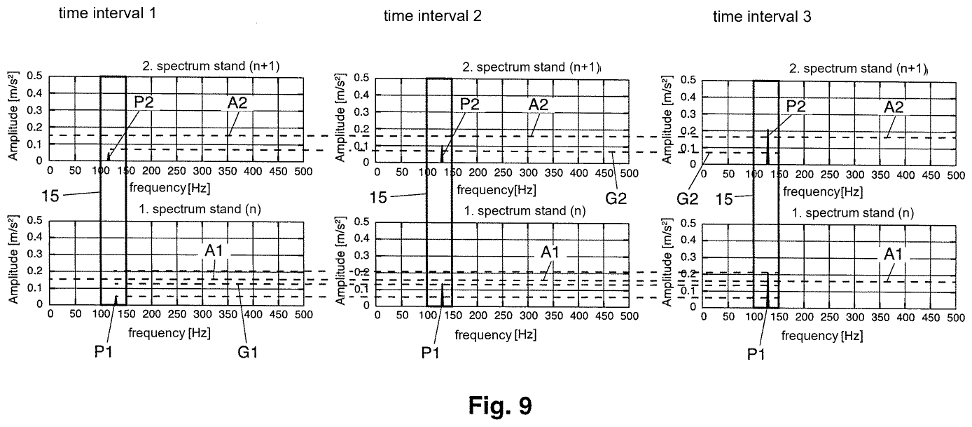

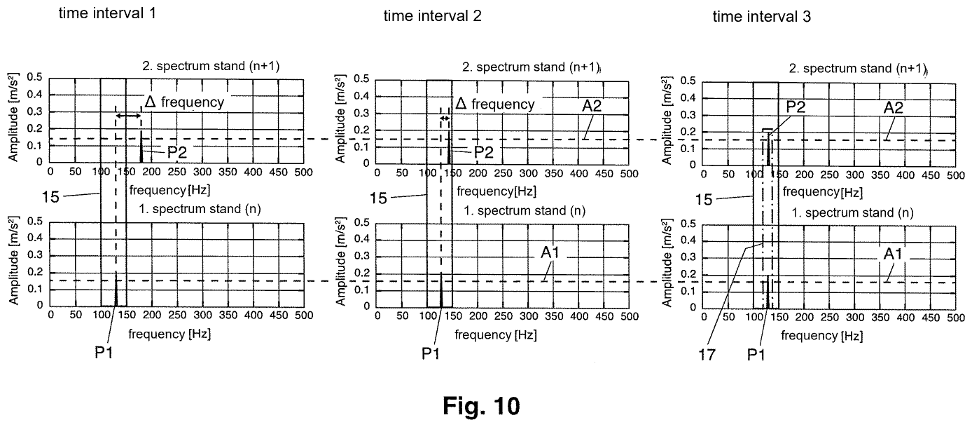

FIG. 9 illustrates a further exemplary embodiment with which the amplitude of the first peak P1 and the amplitude of the second peak P2 in the spectrum for the time interval 1 are in each case still below their respective amplitude threshold values A1 and A2 and preferably also still below their limit values G1 and G2. In this case, the spectra for the first rolling mill stand n and for the second rolling mill stand n+1 must also be determined and compared with one another not only for the first time interval 1, but also for at least one second time interval 2. In accordance with FIG. 9, for the spectra for the second time interval 2, an increase in amplitude for both the first peak P1 and the second peak P2 can be recognized, in each case in the direction of their associated amplitude threshold values A1 and A2. In this respect, a first advance warning can also be issued in this case for a possible chatter event in the future, which occurs if the amplitudes of both the first peak P1 and the second peak P2 are in each case above their respective amplitude threshold values A1 and A2, as shown for the time interval 3.

With reference to FIGS. 7-9 , the development of the amplitudes of the peaks P1 and P2 over time was examined and, if applicable, a first advance warning was issued.

FIG. 10, on the other hand, illustrates the temporal development of the frequency of a peak, which can also be used to issue a (second) advance warning with regard to the possible future occurrence of a chatter event. In an initial situation, FIG. 10 shows the first and second amplitude spectra in each case for a time interval 1. It can be seen that only the first peak P1 is within the common frequency range 15, while the second peak P2 is outside the common frequency range 15. The frequency spacing amounts to 4. The first check step f) would not be fulfilled here because the first peak P1 and the second peak P2 are not both within the common frequency range 15. In this case, it may be advisable to check whether the frequency of the second peak P2 changes in the course of time and approaches the frequency of the first peak P1.

For this purpose, the first amplitude spectrum and the second amplitude spectrum are also generated for a second time interval 2 in addition to the time interval 1. A comparison of the second amplitude spectrum for the time interval 1 and for the time interval 2 shows a reduction in the frequency spacing A in time interval 2. With the frequency of the first peak in the first amplitude spectrum unchanged, the frequency spacing in the second amplitude spectrum has now decreased to such an extent that the frequency of the second peak P2 is within the common frequency range 15. This fulfills the first check step f). Furthermore, since both the amplitude of the first peak and the amplitude of the second peak are in each case above their amplitude threshold values A1 and A2, the second check step g) is also fulfilled here; the requirements for detecting the chatter event are thus met.

Optionally, the first amplitude spectrum and the second amplitude spectrum can also be considered for a third time interval 3; see the two graphs on the right, arranged one above the other, in FIG. 10. If, in this case, it is also determined that the first peak P1 and the second peak P2 are not only within the common frequency range 15, but also within the even narrower common frequency range 17, then this again indicates a particularly high similarity of the spectra, the presence of which additionally underpins the detection of the chatter event.

FIGS. 7-10 in each case show only examples of a temporal development of the amplitudes and/or frequencies of the peaks up to more critical situations that make the occurrence of a chatter event probable. Conversely, however, it is also true that a constant or decreasing amplitude of a peak or a constant or increasing frequency spacing between the first and second peak over time does not change or reduce the probability of the occurrence of a chatter event.

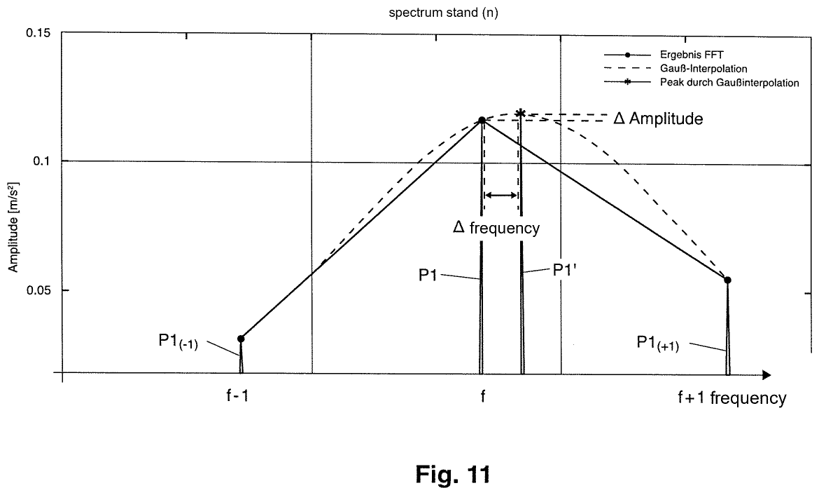

FIG. 11 illustrates a method for improving the resolution of the first and/or second amplitude spectrum. In reality, the first and/or second amplitude spectrum typically does not consist of only a single peak, as was shown in the previous figures for the sake of simplicity in each case, but rather of a plurality of peaks P1_{(f-1)}, P1, P1_{(f+1)}, i.e., the first peak P1 with the frequency f and/or the second peak P2 typically have neighboring peaks in their immediate frequency vicinity, with slightly lower frequency _{f-1} and/or slightly higher frequency _{f+1}. An interpolation of these amplitude spectra can, for example, lead to a change/a correction of the amplitude and/or the frequency of the respective first and/or second peak, as illustrated for the first peak P1 in FIG. 11. The amplitude and frequency of the first interpolated peak P1′ are considered to be more precise than the frequency and amplitude of the non-interpolated first peak P1. Therefore, the method provides that the first and/or second amplitude spectrum are preferably interpolated prior to performing one of the check steps and/or one of the comparison steps. These check/comparison steps are then performed with the amplitudes and frequencies of the interpolated peaks P1′; see the first optional intermediate step in FIG. 1.

The detection of the chatter event and/or at least one of the advance warnings for a future occurrence of the chatter event are issued to an operator of the system and/or to an automatic process control of the system in accordance with the method. The issuance of this information can be linked to a recommendation to slow down the system in order to prevent further build-up/the occurrence of the chatter event. This applies in particular if at least the frequency of one of the peaks is less than a predetermined frequency spacing away from at least one of the natural frequencies of the rolling mill stands.

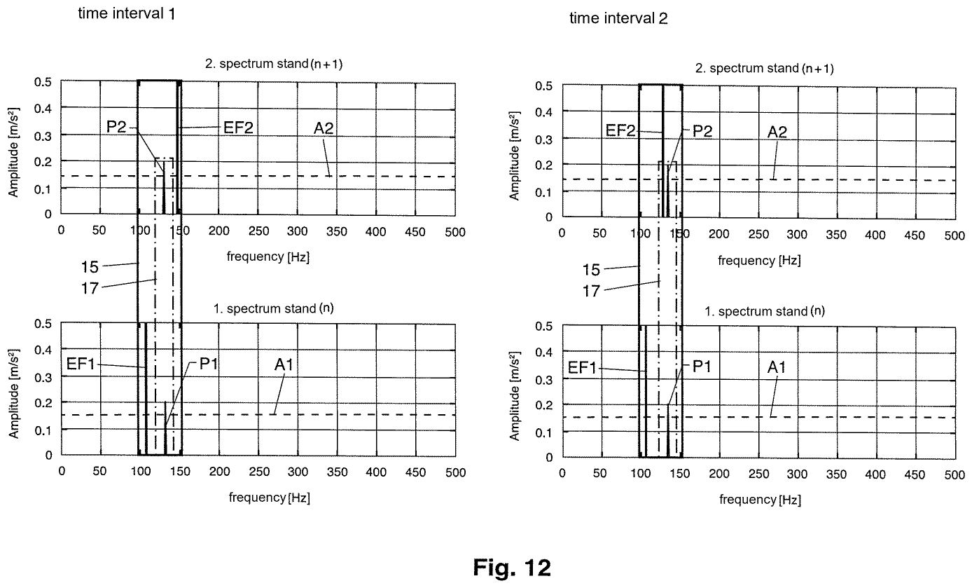

Possible case scenarios on this topic are shown in FIG. 12. The graph at the bottom left of FIG. 12 shows the first amplitude spectrum for the first rolling mill stand n for a first time interval 1. In addition, the second amplitude spectrum for the second rolling mill stand n+1 for the same first time interval 1 is shown. It can be seen that both the first peak P1 of the first amplitude spectrum and the second peak P2 of the second amplitude spectrum in each case fulfill the conditions of the first check step f) and the second check step g) respectively. That is, the two peaks P1 and P2 are both in the common frequency range 15 and their amplitudes are in each case above their respective amplitude threshold values A1 and A2. In accordance with the method, this would actually fulfill the requirements for detecting the chatter event. This is all the more true because both the first peak P1 and the second peak P2 are within the further common frequency range 17 and thus exhibit an even greater degree of correspondence.

However, it can also be seen in the two spectra for the time interval 1 that both a natural frequency EF1 of the first rolling mill stand n and a natural frequency EF2 of the second rolling mill stand n+1 are in each case outside the further/narrower common frequency range 17. Based on this situation, in principle the detection of the chatter event recognized here could be relativized and questioned. That is: The situation could be classified as not so critical with regard to the occurrence of the chatter event, because the peaks still have a sufficient frequency spacing to the natural frequencies EF1 and EF2 of the rolling mill stands.

The same description applies to the right-hand half of FIG. 12 as to the left-hand half of FIG. 12, with the following differences: The spectra shown on the right refer to a different, second time interval 2 and it can be seen that the natural frequency EF2 of the second rolling mill stand n+1 falls here, by way of example, within the further common frequency range 17 of the first and second peaks P1 and P2. In this case, the original detection of the chatter event is answered in the affirmative and confirmed, since the immediate proximity of the frequency of the second peak P2 to the critical natural frequency EF2 of the second rolling mill stand can lead to an undesirable build-up of the vibrations/to undesirable resonance effects.

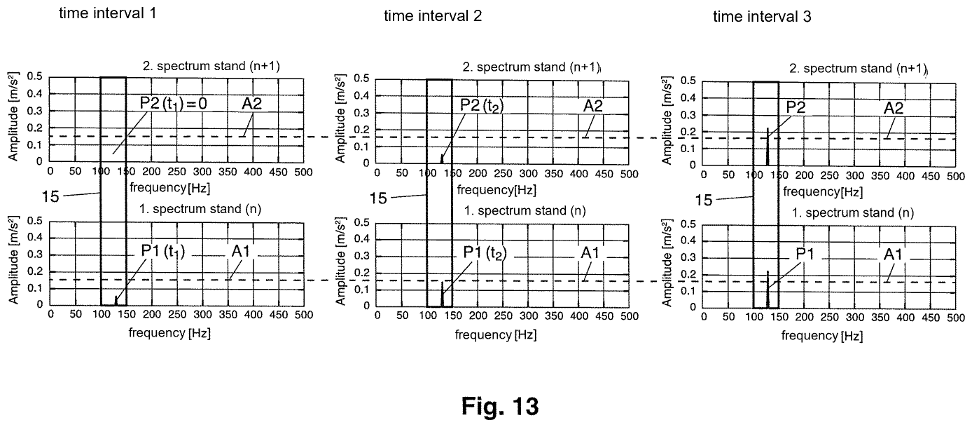

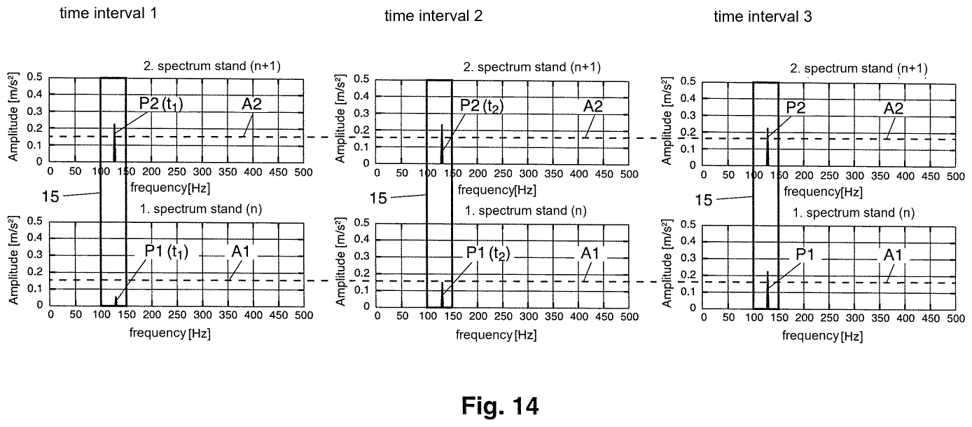

FIGS. 13 and 14 in each case illustrate the amplitude gradient as a further criterion that can be used as an indication of the future occurrence of a chatter event in addition to the two mandatory criteria in accordance with method steps f) and g) optionally also in combination with one or more of the other criteria described above. Specifically, this criterion checks whether or not the (temporal) gradient of the amplitudes of two peaks in amplitude spectra over different time intervals is above a gradient threshold value.

In other words: With the gradient criterion, a comparison is carried out between the amplitudes Pn of the peaks in an amplitude spectrum at a current time interval (t=t₂) and the amplitudes of the peaks in an amplitude spectrum from a past time interval (t=t₁) at a certain, predetermined time difference (t₂−t₁=Δt=const.) for one rolling mill stand n. This makes a gradient evaluation of the amplitudes possible as follows:

grad Pn=(Pn(t₂)−Pn(t₁))/Δt (1)

If the gradient calculated in this manner is above a gradient threshold value Gn, this is interpreted as an additional indication of the possible occurrence of a chatter event at least at the rolling mill stand n; and vice versa. If the gradient evaluation is positive, a preliminary warning is issued to the operator or to the automatic control system of the rolling milling stand, indicating that an exceeding of the amplitude is to be expected at least at this rolling mill stand.

FIG. 13 illustrates the gradient evaluation on rolling mill stand n, on the one hand, and on a downstream rolling mill stand n+1, on the other hand. For both rolling mill stands, the amplitudes of the peaks within time intervals 1 and 2 are, here by way of example, below the respective amplitude threshold values A1/A2. The gradient evaluation is carried out separately for the rolling mill stand n=1 and for the rolling mill stand n+1=2 in each case in accordance with the formula (1). For both rolling mill stands, the determined gradient grad P1 and grad P2 are in each case above the individually assigned gradient threshold values G1/G2 (not shown in FIG. 13). This suggests that at a future time interval 3, the amplitudes of the peaks of the amplitude spectra for both rolling mill stands will be above their individual amplitude threshold values A1/A2. The occurrence of these expected events is shown in the right-hand graphs in FIG. 13.

FIG. 14 illustrates the gradient evaluation using only rolling mill stand n by way of example. For the neighboring rolling mill stands n+1, it was assumed for simplification that the amplitudes of the peaks in the amplitude spectra over the time intervals 1, 2 and 3 are always above the associated amplitude threshold value A2. For this reason, only a gradient evaluation is required for the rolling mill stand n. For the rolling mill stand n, the amplitudes of the peaks within time intervals 1 and 2 are below the respective amplitude threshold value A1. The gradient evaluation is carried out in accordance with formula (1) for the rolling mill stand n=1. For the rolling mill stand n, the determined gradient grad P1 is above the gradient threshold value (not shown in FIG. 14). This suggests that the amplitude of the peaks of the amplitude spectrum for the rolling mill stand n will also be above the individual amplitude threshold value Al at a future time interval 3. The occurrence of this expected event is shown in the lower right-hand graph in FIG. 14. The upper right-hand graph in FIG. 14 shows that the amplitude of the peak in the amplitude spectrum for the neighboring rolling mill stand n+1 is still above the amplitude threshold value A2 even over the later time interval 3.

### LIST OF REFERENCE SIGNS

A1 First amplitude threshold value
A2 Second amplitude threshold value
15 Common frequency range
17 Narrower common frequency range
EF1 Natural frequency of the first rolling mill stand
EF2 Natural frequency of the second rolling mill stand
G1 First limit value
G2 Second limit value
KO Correlation threshold value
n First rolling mill stand
n₊₁ Second rolling mill stand
P1 First peak
P1′ First interpolated peak
P1_{(f-1)} Neighboring peak with lower frequency than P1
P1_{(f+1)} Neighboring peak with higher frequency than P1
P2 Second peak
Δ Frequency difference/frequency spacing
t₁ Time interval 1
t₂ Time interval 2

1.-10. (canceled)

11. A method for analyzing vibration behavior of a system comprising at least a first rolling mill stand and a second rolling mill stand coupled to one another via a strip clamped in the first rolling mill stand and the second rolling mill stand, the method comprising the following steps:
a) capturing vibrations at the first rolling mill stand with a first sensor as a first temporal vibration signal;
b) capturing vibrations at the second rolling mill stand with a second sensor as a second temporal vibration signal simultaneously with capturing the vibrations at the first rolling mill stand;
c) transforming the first temporal vibration signal in a first time interval into the frequency domain resulting in a first amplitude spectrum for the first time interval;
d) transforming the second temporal vibration signal in the first time interval into the frequency domain resulting in a second amplitude spectrum for the first time interval;
e) identifying a common frequency range in which the first amplitude spectrum and second amplitude spectrum are compared with one another;
f) checking whether there is at least one first peak in the first amplitude spectrum and at least one second peak in the second amplitude spectrum, both the at least one first peak and the at least one second peak being in the common frequency range;
g) checking whether the first peak exceeds a predetermined first amplitude threshold value (A1) and the second peak exceeds a second predetermined amplitude threshold value (A2); and
h) detecting a chatter event in case the two checking steps f) and g) each yield a positive result.

12. The method according to claim 11,
further comprising, in response to the checking step f) yielding a positive result and the checking step g) yielding a negative result due to the first peak (P1) being below the first amplitude threshold value (A1):
transforming at least a second time interval of the first vibration signal into the frequency domain resulting in the first amplitude spectrum for at least the second time interval;
comparing the peaks of the first amplitude spectrum in the common frequency range (15) for the first time interval and for at least the second time interval with one another to determine whether an increase in the amplitude of the peak for the second time interval compared with the amplitude of the peak for the first time interval beyond a lower limit value (G1) below the first amplitude threshold (A1) is recognizable as a first early indicator; and
issuing a first advance warning that a critical chatter of the system could occur if the first early indicator is given, and the second peak in the common frequency range is above the second amplitude threshold value (A2) for at least one of the first time interval or the second time interval.

13. The method according to claim 11,
further comprising, in response to the checking step f) yielding a positive result and the checking step g) yielding a negative result due to the second peak (P2) being below the second amplitude threshold value (A2):
transforming at least a second time interval of the second vibration signal into the frequency domain resulting in the second amplitude spectrum for at least the second time interval;
comparing the peaks (P2) of the second amplitude spectrum in the common frequency range (15) for the first time interval and for at least the second time interval with one another to determine whether an increase in the amplitude of the peak (P2) for the second time interval compared with the amplitude of the peak (P2) for the first time interval beyond a lower limit value (G2) below the second amplitude threshold value (A2) is recognizable as a second early indicator; and
issuing a first advance warning that a critical chatter of the system could occur if the second early indicator is given, and the second peak in the common frequency range is above the first amplitude threshold value (A1) for at least one of the first time interval or the second time interval.

14. The method according to claim 11,
further comprising, in response to the checking step f) yielding a positive result and the checking step g) yielding a negative result due to the first peak (P1) being below the first amplitude threshold value (A1) and the second peak (P2) being below the second amplitude threshold value (A2):
transforming at least a second time interval of the first vibration signal into the frequency domain resulting in the first amplitude spectrum for at least the second time interval;
comparing the peaks of the first amplitude spectrum in the common frequency range (15) for the first time interval and for at least the second time interval with one another to determine whether an increase in the amplitude of the peak for the second time interval compared with the amplitude of the peak for the first time interval beyond a lower limit value (G1) below the first amplitude threshold (A1) is recognizable as a first early indicator; and
transforming at least the second time interval of the second vibration signal into the frequency domain resulting in the second amplitude spectrum for at least the second time interval;
comparing the peaks (P2) of the second amplitude spectrum in the common frequency range (15) for the first time interval and for at least the second time interval with one another to determine whether an increase in the amplitude of the peak (P2) for the second time interval compared with the amplitude of the peak (P2) for the first time interval beyond a lower limit value (G2) below the second amplitude threshold value (A2) is recognizable as a second early indicator; and
issuing a first advance warning that a critical chatter of the system could occur if the early indicator is given in each of the two comparing steps.

15. The method according to claim 11,
further comprising, in response to the checking step f) yielding a negative result due to the first peak (P1) and/or the second peak (P2) being outside the common frequency range (15):
transforming at least a second time interval of the first vibration signal or the second vibration signal into the frequency domain resulting in a relevant amplitude spectrum for at least the second time interval;
comparing the peaks of the relevant amplitude spectrum in the common frequency range (15) for the first time interval and for at least the second time interval with one another to determine whether a shift of the frequency of the peak for the second time interval compared to the frequency of the peak for the first time interval has taken place into at least a defined vicinity around the common frequency range (15); and
issuing a second advance warning that a critical chatter of the system could occur in case
the frequency of the peak for the second time interval has entered the vicinity of the common frequency range (15), and
the checking step g) yields a positive result.

16. The method according to claim 11,
wherein detecting the chatter event only takes place in case
a correlation of the first signal and the second signal in the time interval is above a correlation threshold value (KO); and/or
natural frequencies of the first rolling mill stand (EF1) and/or the second rolling mill stand (EF2) are within the common frequency range (15) and also within a narrower common frequency range (17); and/or
the frequency of the first peak (P1) and the frequency of the second peak (P2) are within a further common frequency range (17), which is narrower than the common frequency range (15); and/or
an amplitude gradient determined in accordance with a formula
grad Pn=(Pn(t2)−Pn(t1))/Δt (1)
is above an individual gradient threshold value (G1) for the first rolling mill stand n=1, wherein the following applies:
n rolling mill stand
t1, t2 time interval 1, time interval 2
Δt time difference t2−t1=constant
Pn amplitude of the peak for the rolling mill stand n1
and either the amplitude of the peaks of the amplitude spectrum of the second rolling mill stand (P2) have already been or are above an associated amplitude threshold value (A2) during time intervals 1, 2 and 3, or the gradient for the second rolling mill stand in accordance with the formula (1) is also above an individual gradient threshold value (G2).

17. The method according to claim 11, further comprising interpolating the first and/or the second amplitude spectrum in the frequency domain prior to performing one of the checking steps.

18. The method according to claim 11, wherein detecting the chatter event is issued to an operator of the system or an automatic process control of the system with a recommendation to decelerate the system.

19. The method according to claim 11, wherein the first rolling mill stand and the second rolling mill stand are cold rolling mill stands.

20. A computer program product stored on a non-transitory medium that can be loaded directly into an internal memory of a digital computer and comprises sections of software code with which the steps of claim 11 are performed when the product is running on the computer.
